(19) United States
(12) Patent Application Publication
(10) Pub. No.: US 2025/0357883 A1
(43) Pub. Date: Nov. 20, 2025

(54) AGRIVOLTAIC SYSTEM AND METHOD

(71) Applicant: THE STATE OF ISRAEL, MINISTRY OF AGRICULTURE & RURAL DEVELOPMENT, AGRICULTURAL RESEARCH ORGANIZATION, Rishon-LeZion (IL)

(72) Inventors: Eran RAVEH, Midreshet Ben Gurion (IL); Elena VITOSHKIN, Mazkeret Batya (IL)

(21) Appl. No.: 18/869,439

(22) PCT Filed: May 31, 2023
(86) PCT No.: PCT/IL2023/050562

§ 371 Date: Nov. 26, 2024

Related U.S. Application Data
(60) Provisional application No. 63/347,765, filed on Jun. 1, 2022.

(51) Int. Cl. H02S 20/32; A01G 9/24; A01G 13/21; G01K 3/14

(52) U.S. Cl. CPC H02S 20/32; A01G 9/243; A01G 13/21; G01K 3/14

(57) ABSTRACT

The present disclosure provides a method in an agrivoltaic system comprising photovoltaic panels disposed to cast a shadow on plants when irradiated by sunlight. The photovoltaic panels are controllable for adjusting said shadow. The method comprises obtaining a comparison signal indicative of a comparison between a temperature of ambient air and a temperature of the plants; and controlling one or more of said photovoltaic panels to adjust the shadow cast by said one or more photovoltaic panels on the plants using said comparison signal.

### TECHNOLOGICAL FIELD

This invention relates to the field of agrivoltaics, and in particular to a system and a method for controlled sun tracking of photovoltaic panels.

### BACKGROUND

The concept of agrivoltaics (also referred to as agrophotovoltaics) was initially proposed in the eighties as a means of modifying solar power plants to enable additional crop production on the same area. The idea was to raise the solar panels to a few meters above the ground and increase the spacing between them to avoid excessive shading of the crops.

Dynamic agrivoltaic systems improved on the original concept by using movable photovoltaic (PV) panels (also referred to as dynamic PV panels). Movable PV panels are controllably orientable and offer means to increase agrivoltaic systems performance.

Movable PV panels can work in a so-called “sun tracking mode” in which the PV panels move during the whole day to keep facing the sun thereby maximizing electricity production. For example, an orientation of the PV panels can be adjusted whenever there is a 1° offset between the PV panels and the sun angular directions.

Recently, it was proposed to use movable PV panels in a so-called “controlled tracking mode” aimed, in the morning and late afternoon, at increasing solar radiation at plant level by minimizing the area shaded by panels whilst maximizing the shading of the plant at solar noon when temperature, evaporative demand and light conditions peaked with possible limitation of plant growth. (“Increasing the total productivity of a land by combining mobile photovoltaic panels and food crops”, Valle et al. 2017).

However, algorithms to control effectively the movable PV panels that would consider the sugar level, amount of the crop, season, or time of a day are difficult to design. Additionally, models underlying said algorithms generally need adjustment and/or calibration to be adapted to the specific conditions such as soil water stress and the other variables incorporated in the light response curve. Such adjustments require a large amount of research studies. Therefore, there is a need for improved tools to allow effective use of movable PV panels.

### SUMMARY

In accordance with a first aspect of the presently disclosed subject matter, there is provided a method in an agrivoltaic system comprising photovoltaic panels disposed to cast a shadow on plants when irradiated by sunlight. The photovoltaic panels are controllable for adjusting said shadow and the method comprises: (a) obtaining a comparison signal indicative of a comparison between a temperature of ambient air and a temperature of the plants; and (b) controlling one or more of said photovoltaic panels to adjust the shadow cast by said one or more photovoltaic panels on the plants using said comparison signal.

In addition with the above features, the method according to this aspect of the presently disclosed subject matter can optionally comprise one or more of features (i) to (xiii) below, in any technically possible combination or permutation:
i. the controlling of said photovoltaic panels is performed to maintain a predetermined relationship between the temperature of the plants and ambient air temperature.
ii. the comparison signal is indicative of a difference and/or a ratio between ambient air temperature and the plant temperature.
iii. controlling one or more of said photovoltaic panels using the comparison signal comprises determining whether said difference or ratio between ambient air temperature and the plant temperature exceeds a threshold.
iv. the comparison signal is obtained repeatedly over time and wherein controlling one or more of said photovoltaic panels using said comparison signal comprises using the comparison signal obtained at several points in time.
v. controlling one or more of said photovoltaic panels comprises: (a) determining a current shadow cast by the photovoltaic panels on the plants; (b) computing a desired shadow adjustment of the shadow cast by said one or more photovoltaic panels on the plants using said comparison signal; and (c) controlling one or more of said photovoltaic panels to achieve said desired shadow adjustment.
vi. controlling one or more photovoltaic panels is performed such that the shadow cast by said one or more photovoltaic panels on the plants is increased when the signal is indicative that the temperature of the plants increases and approaches or exceeds ambient air temperature.
vii. controlling one or more photovoltaic panels is performed such that the shadow cast by said one or more photovoltaic panels on the plants is decreased when the signal is indicative that the temperature of the plants decreases and approaches or goes below ambient air temperature.
viii. the method is performed repeatedly at any of an hourly, daily and/or seasonal periodicity.
ix. the temperature of the plants is a temperature of a canopy of the plants.
x. the photovoltaic panels are movable and controlling said one or more photovoltaic panels comprises adjusting a position and/or an orientation of said one or more photovoltaic panels.
xi. the one or more photovoltaic panels are rotatable around an axis and controlling one or more photovoltaic panels comprises rotating the one or more photovoltaic panels around said axis.
xii. controlling one or more photovoltaic panels is performed to also reduce a decrease in the generation of electricity by the one or more photovoltaic panels.
xiii. the method further comprises an overruling pattern in case of meteorological event.

In accordance with a second aspect of the presently disclosed subject matter, there is provided an apparatus for use in an agrivoltaic system comprising photovoltaic panels disposed so as to cast a shadow on plants when irradiated by sunlight. The photovoltaic panels are controllable for adjusting said shadow. Th apparatus may be configured for performing the method of any of the preceding claims.

In addition with the above features, the apparatus according to this aspect of the presently disclosed subject matter can optionally comprise any of (a) an input port configured to receive a signal indicative of a temperature of ambient air and a signal indicative of a temperature of the plants; (b) an actuator operatively coupled to the photovoltaic panels and configured for controlling said photovoltaic panels; and (c) a processor operatively coupled to the actuator and to the input port and configured for: comparing the temperature of ambient air and the temperature of the plants using the signal indicative of the temperature of ambient air and the signal indicative of the temperature of the plants, thereby obtaining the comparison signal indicative of a comparison between the temperature of ambient air and the temperature of the plants; computing a desired shadow adjustment of the shadow cast by the photovoltaic panels on the plants using said comparison signal; and outputting control commands to the actuator to control one or more of said photovoltaic panels and adjust the shadow cast by said one or more photovoltaic panels on the plants to achieve said desired shadow adjustment.

In accordance with a second aspect of the presently disclosed subject matter, there is provided a photovoltaic system, comprising photovoltaic panels intended to be disposed so as to cast a shadow on plants when irradiated by sunlight, said photovoltaic panels being controllable for adjusting a shadow cast by said photovoltaic panels on the plants; and (b) the apparatus described hereinabove.

In addition with the above features, the photovoltaic system according to this aspect of the presently disclosed subject matter can optionally comprise one or more of features (i) to (vi) below, in any technically possible combination or permutation:
i. a plant temperature sensor configured to provide the signal indicative of the temperature of the plants.
ii. an air temperature sensor configured to provide the signal indicative of the ambient air.
iii. the plant temperature sensor comprises an infrared camera and/or thermocouples.
iv. a solar radiation sensor that may be configured to measure solar radiation received from the sun.
v. at least some fixed photovoltaic panels.
vi. the photovoltaic panels comprise one or more semi-transparent and/or bifacial panels.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 illustrates generally a method of controlling photovoltaic panels according to some embodiments of the present disclosure;

FIG. 2 illustrates generally an agrivoltaics system according to some embodiments of the present disclosure;

FIG. 3 illustrates with more details an agrivoltaics system according to some embodiments of the present disclosure;

FIG. 4A-4C show light response curves for different plant species.

### DETAILED DESCRIPTION OF EMBODIMENTS

In the following detailed description, numerous specific details are set forth in order to provide a thorough understanding of the invention. However, it will be understood by those skilled in the art that the presently disclosed subject matter may be practiced without these specific details. In other instances, well-known methods, procedures, components and circuits have not been described in detail so as not to obscure the presently disclosed subject matter.

Unless specifically stated otherwise, as apparent from the following discussions, it is appreciated that throughout the specification discussions utilizing terms such as “processing”, “computing”, “comparing”, or the like, refer to the action(s) and/or process(es) of a computer that manipulate and/or transform data into other data, said data represented as physical, such as electronic, quantities and/or said data representing the physical objects. The term “computer” should be expansively construed to cover any kind of hardware-based electronic device with data processing capabilities including, by way of non-limiting example, FPEI system and respective parts thereof disclosed in the present application.

Additionally, certain terms used in the present application may be better understood in view of the below explanations:

The term light may refer to visible wavelengths of the electromagnetic spectrum that humans can see i.e. from about 380 nanometers to about 750 nanometers or more specifically to the photosynthetic active radiation spectrum i.e. from about 400 nanometers to about 700 nanometers.

The term photovoltaic panel (also referred to as solar panel) may refer to an assembly of photovoltaic modules. Photovoltaic modules use sunlight as a source of energy to generate direct current electricity. The present disclosure relates particularly to controllable photovoltaic panels for adjusting a shadow cast by said photovoltaic panels when irradiated by sunlight. The photovoltaic panels may be disposed above plants for example on an agricultural land. The photovoltaic panels may rely on different combinable or alternative features to adjust the shadow that they cast. In some embodiments, the controllable photovoltaic panels may include movable panels. In some embodiments, said movable panels may include photovoltaic panels which can be rotated according to one, two or three axes (i.e. rolled and/or pitched and/or yawed). In some embodiments, said movable panels may include photovoltaic panels which can alternatively or additionally be translated according to one, two or three directions. For example, the photovoltaic panels may be disposed as a two-dimensional array above and substantially parallel to the agricultural land and a position of said photovoltaic panels in a direction perpendicular to the two-dimensional array can be adjusted. The photovoltaic panels may additionally or alternatively be adjustable with respect to one or two directions of the two-dimensional array. In some embodiments, a transparency of the photovoltaic panels may alternatively or additionally be controllable thereby adjusting the shadow cast by said photovoltaic panels. In some examples, a transparency of the photovoltaic panels may be controllably adjusted due to inherent properties of the photovoltaic panels such as color tunability. In other examples, the transparency of the photovoltaic panels (e.g. partially transparent panels) may be adjusted by external means such as controllably covering one or more of the photovoltaic panels.

The term plant canopy may refer to an upper layer of a plant. The term upper layer may refer to a portion of the plant visible from above the plant when the plant is growing naturally from the ground.

The term shadow may refer to a region where a part of sunlight is obscured.

The term ambient air temperature may refer to a temperature measured at a plant level i,e. the ambient air temperature may be indicative of a temperature of air surrounding a plant. For example, an ambient air temperature sensor may be positioned on a pole of a photovoltaic panel supporting frame.

The term plant temperature may refer to a temperature of a portion of the plant. For example, the plant temperature may refer to a temperature of a plant canopy. The plant temperature may be sensed from above the plant canopy, for example from a height of about 1 to 5 meters above the top of the plant. The temperature of the plant may for example be sensed using an infrared sensor. The plant temperature may refer to an average temperature over a plurality of plants for example located in a field of view of the infrared sensor.

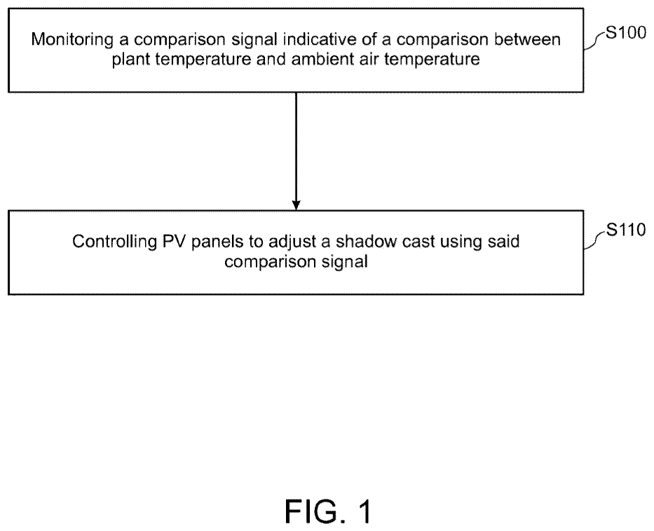

FIG. 1 is a box diagram illustrating generally steps of a method for controlling photovoltaic panels according to the present disclosure. The method may be performed on a controller apparatus of an agrivoltaic system comprising photovoltaic panels disposed so as to cast a shadow on plants when irradiated by sunlight. The photovoltaic panels are controllable for adjusting the shadow that they cast on the plants. In some embodiments, the PV panels are movable and the motion of the PV panels is controllable for adjusting the shadow they as on the plants. For example, the photovoltaic panels are movable.

The method comprises a first step S100 of obtaining a comparison signal indicative of a comparison between plant temperature and ambient air temperature. In some embodiments, the plant temperature is a temperature of a canopy of the plants. The plants may be a citrus orchard for example a mandarin orchard and particularly an Orri mandarin orchard. In some embodiments, the plant temperature is sensed by an infrared sensor and a signal indicative of the plant temperature is provided to the controller apparatus. In some embodiments, the ambient air temperature is sensed by the same or another infrared sensor and provided to the controller apparatus. In some other embodiments, the controller apparatus is capable of exchanging data on an external communication network and ambient air temperature is retrieved from meteorological information systems in communication with the controller apparatus. In some embodiments, the comparison signal is indicative of a difference between the plant temperature and ambient air temperature.

The method comprises a second step S110 of controlling the photovoltaic panels to adjust a shadow cast by one or more of the photovoltaic panels using said comparison signal. Through experiments on citrus orchards, the applicant has found that plant temperature (in particular canopy temperature) and air temperature difference actually reflects the main factors that affect the light requirements of trees such as tree water availability; carbohydrate accumulation level in leaves and crop conditions.

In the present disclosure, step S110 and other steps involving the term “control” or it derivatives may be split in at least a sub-step of computing control commands—typically performed on a processor—and a sub-step of commanding—typically performed on an actuator operatively coupled to the controlled entity. In particular, step S110 comprises a sub-step of computing control commands to adjust the shadow cast by one or more of the photovoltaic panels using said comparison signal—which may be performed on a processor receiving the comparison signal—and a sub-step of commanding the one or more photovoltaic panels using said control commands to adjust the shadow cast by said one or more photovoltaic panels—which may be performed by an actuator which is operatively coupled to the one or more photovoltaic panels and to the processor. The processor may be operatively coupled to the actuator i.e. the actuator is configured to be operated by the processor. For example, the actuator and processor may be configured to exchange data on a wired or wireless network. The actuator may be operatively coupled to the one or more photovoltaic panels i.e. the one or more controllable photovoltaic panels are configured to be operated by the actuator. In some embodiments, the processor and the actuator may be implemented on the same apparatus. In some embodiments, the processor and the actuator may be implemented in separate apparatuses. In some embodiments, the actuator may comprise multiple actuating modules each operatively coupled to at least one of the one or more photovoltaic panels.

Step S110 may comprise controlling said photovoltaic panels so as to maintain a predetermined relationship between the temperature of the plants and ambient air temperature. For example, the controlling of the photovoltaic panels may be performed so that a difference between plant temperature and ambient air temperature is kept below a threshold. In another example, the controlling of the photovoltaic panels may be performed so that the temperature difference is kept between a minimum and maximum limit. In some embodiments, Step S110 of controlling said one or more photovoltaic panels may be performed to also reduce a decrease in the generation of electricity by the one or more photovoltaic panels. Additionally, the control method may comprise an overruling pattern in case of meteorological event such as a heatwave, a rainfall, hail, or the like. In some embodiments, the comparison signal may be obtained repeatedly over time and step S110 may comprise using the comparison signal obtained at several points in time. This may enable to detect and take in account trends of the comparison signal in the control routine. In some embodiments, Step S110 comprises determining a current shadow cast by the photovoltaic panels on the plants; computing a desired shadow adjustment of the shadow cast by said one or more photovoltaic panels on the plants using said comparison signal; and controlling one or more of said photovoltaic panels to achieve said desired shadow adjustment. The shadow adjustment may be performed stepwise. For example, if based on the comparison signal, it is determined that the shadow needs adjustment (e.g. because the comparison signal reached a predefined threshold value), the shadow may be increased or decreased of a predetermined shadow step adjustment. The shadow step adjustment may be predefined as a percentage of the current shadow cast (e.g. ±10% or ±20%). After each shadow step adjustment, the method may include waiting for a waiting period elapses (e.g. 0 or 20 minutes) and thereafter checking of the comparison signal to determine if implementing a further shadow step adjustment is needed (e.g. checking if the comparison signal has returned below the predefined threshold value) . . . In some embodiments, step S110 is performed such that the shadow cast by said one or more photovoltaic panels on the plants is increased when the signal is indicative that the temperature of the plants increases and approaches or exceeds ambient air temperature. In fact, once the stomata have closed for any reason (whether as a result of a water restriction in the soil or a limited ability to transfer water from the soil to the leaves related to the hydraulics of the transport system, or as a result of the photosynthetic saturation) leaf temperature rises above air temperature. At this point, an increase in a shadow level is beneficial. In some embodiments, step S110 is performed such that the shadow cast by said one or more photovoltaic panels on the plants is decreased when the signal is indicative that the temperature of the plants decreases and approaches or goes below ambient air temperature.

The Applicant hereby proposes a dynamic tracking algorithm to control adjustable photovoltaic panels using a comparison between leaf temperature and air temperature for an optimal shading level. The results of the experiments caried out by the Applicant have helped developing an improved solar tracking algorithm for optimizing both the distribution of solar radiation over agricultural land and particularly an orchard and effective electricity generation. The present disclosure provides for a controlled tracking system based on plant response to radiation and microclimatic variations as plants light requirements determine the position of the photovoltaic panels. The effect of radiation and microclimatic heterogeneity on the crop is taken into account by monitoring the air and foliage temperature difference which reflect the interaction of most factors that affect the light requirement of plants and in particular of trees.

Canopy to air temperature difference integratively reflects the shading requirements of the trees and can be used to manage the shading level of the photovoltaic panels. As soon as the canopy temperature approaches or even rises beyond the air temperature for any reasons, a tree is exposed to excess radiation and the level of shading obtained from the panels have to be increased. Usually, this occur in the afternoon, when the leaf sugar stores are full, or under any environmental strain causes to the closure of stomata, such as high heat rate, or limitation of water transfer caused by dehydration in the soil or hydraulic limitation of the transport system. Adjusting the level of shading considering the canopy-air temperature difference reduces requirement for calibrations over different parameters, different environmental conditions, or the fruit load and reflects the requirements for reducing the light intensity of the tree.

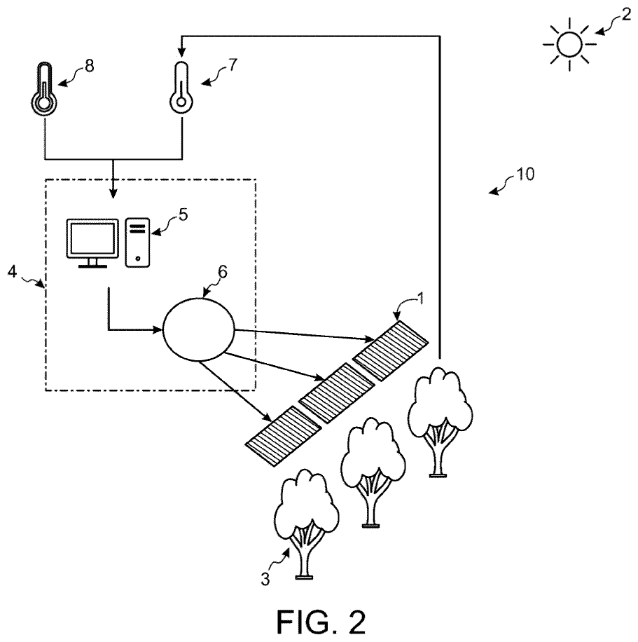

FIG. 2 is a schematic view of an agrivoltaic system 10 according to some embodiments of the present disclosure. The agrivoltaic system 10 comprises photovoltaic panels 1 disposed so as to cast a shadow on plants 3 when irradiated by the sun 2. The photovoltaic panels 1 are controllable to adjust a shadow cast on the plants 3. The agrivoltaic system 10 further comprises a controller apparatus 4 for implementing the method according to the present disclosure. The controller apparatus 4 may include a processor 5 for computing control commands according to the control method of the present disclosure, said control commands being implemented by an actuator module 6 operatively coupled to the photovoltaic panels and configured for controlling said photovoltaic panels. The actuator module 6 may be operatively coupled to the one or more photovoltaic panels 1 i.e. the one or more controllable photovoltaic panels 1 are configured to be operated by the actuator module 6. The processor 5 may be operatively coupled to the actuator module 6 i.e. the actuator module 6 is configured to be operated by the processor 5. For example, the actuator module 6 and processor 5 may be configured to exchange data via wired or wireless transmission. In some embodiments, the actuator module 6 may include one or more actuators (not shown) operatively coupled to the photovoltaic panels and configured for controlling said photovoltaic panels 1. In some embodiments, each photovoltaic panel 1 may be operatively coupled to an actuator. In some embodiments, an actuator may be configured for controlling several photovoltaic panels. In some embodiments, the actuators may be integrated to the photovoltaic panels 1 or to a frame onto which the photovoltaic panels 1 may be mounted to.

The controller apparatus 4 is configured to obtain a comparison signal indicative of a comparison between a temperature of the plants canopy 3 and the temperature of ambient air. In some embodiments, a canopy temperature sensor 7 and an ambient air temperature sensor 8 are configured to provide respective signals indicative of the canopy temperature and the ambient air temperature to the controller apparatus 4. The canopy temperature sensor 7 may comprise an infrared sensor (e.g. an infrared camera) and/or thermocouples. The controller apparatus 4 may include an input port configured to receive said signals. The processor 5 may be operatively coupled to said input port so as to receive said signals. The processor 5 may be configured to compute the comparison signal from the signal indicative of the canopy temperature and the signal indicative of ambient air temperature. In other embodiments, the comparison signal may be computed remotely and received by the input port. The processor 5 may further be configured to compute control commands for adjusting the shadow cast by one or more photovoltaic panels based on the comparison signal. The processor 5 may provide the control commands to the actuator module 6 for controlling the one or more photovoltaic panels accordingly i.e. using said computed control commands. In other words, the photovoltaic panels are piloted automatically by the controller apparatus 4. The controller apparatus 4 may run a control routine using the comparison signal. The control routine may include a stepwise adjustment of the shadow cast by the PV panels, for example by controlling the panels position relative to the direction of solar radiation. Also, the control routine may be based on the plant saturation graphs (if the data is available). In some embodiments, the control routine may be overruled in case of meteorological event such as hail, heatwave, rain, extreme low night-time temperatures and the like. The control routine may also reduce a decrease in the generation of electricity by the one or more photovoltaic panels. In order to do so, the agrivoltaic system 10 may comprise an irradiation sensor capable of computing an angle of solar irradiation. The irradiation sensor may allow limiting the electricity generation decrease by maintaining at least partial sun tracking.

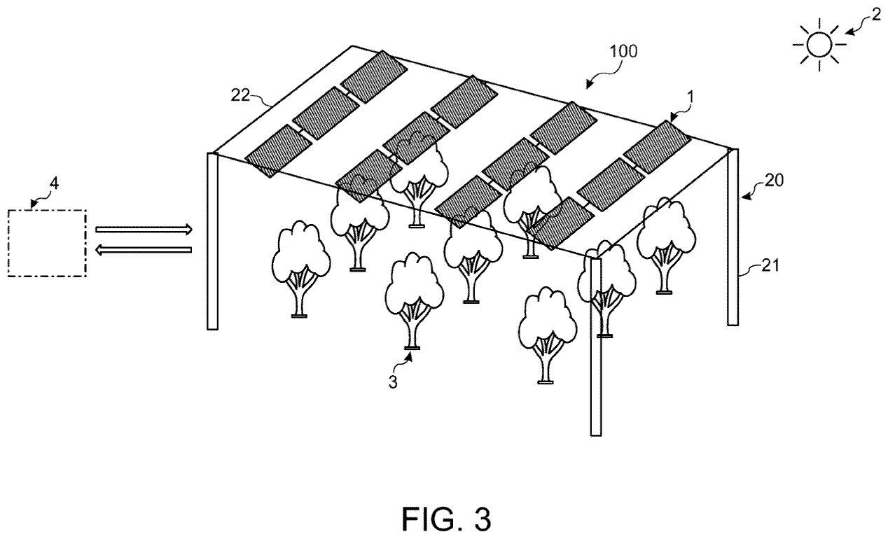

FIG. 3 is a more detailed view of an agrivoltaic system 100 according to some embodiments of the present disclosure. Same reference numerals between FIG. 2 and FIG. 3 refer to the same features. For the sake of brevity, only components which differ are herein described in details. The agrivoltaic system 100 comprises photovoltaic panels 1 disposed so as to cast a shadow on plants 3 on an agricultural land when irradiated by the sun 2. The photovoltaic panels 1 are controllable to adjust a shadow cast on the plants 3. The agrivoltaic system 100 further comprises a controller apparatus 4 for implementing the method according to the present disclosure. The controller apparatus 4 may include a processor for computing control commands according to the control method of the present disclosure, said control commands being implemented by an actuator module operatively coupled to the photovoltaic panels and configured for controlling said photovoltaic panels. The controller apparatus 4 is configured to obtain a comparison signal indicative of a comparison between a temperature of the plants canopy 3 and the temperature of ambient air. In the agrivoltaic system 100, the photovoltaic panels 1 may be arranged on a supporting frame 20 and form a two-dimensional photovoltaic array substantially parallel to the agricultural land. The frame 2 may include poles 21 that support a framework 22 onto which the photovoltaic panels 1 are mounted. The supporting frame 20 may be dimensioned so that the photovoltaic panels are raised at about 3 to 5 meters above the ground to allow for a clearance for agricultural machinery and operators working with the plants 3. In some embodiments, each photovoltaic panels 1 may be independently controllable to adjust a shadow cast on the plants 3. In other embodiments, the photovoltaic panels 1 may be adjustable by group. For example, each row or column of the two-dimensional photovoltaic array may form a group. The photovoltaic panels 1 may be movable. For example, a position of said photovoltaic panels in a direction perpendicular to the two-dimensional array can be adjusted. The photovoltaic panels may additionally or alternatively be adjustable with respect to one or two directions of the two-dimensional array. In some embodiments, said movable panels can be rotated according to one, two or three axes (i.e. rolled and/or pitched and/or yawed). In some embodiments, the photovoltaic panels are independently rotatable around a single axis. Each photovoltaic panel 1 may be pivoted said axis using an actuator (not shown). The actuators are for example provided individually for each photovoltaic panel. As a variant, an actuator may rotate a plurality of photovoltaic panels. The actuators may for example include one or a plurality of electrical motors, and for example consist of servomotors.

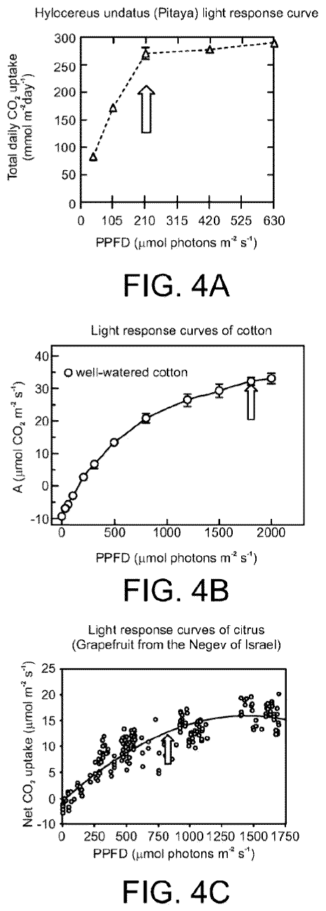

The method and system described in the present disclosure may be particularly useful for plants that need shading at the location where the panels are installed based on the climate at the location and on the light response curve of the plants. In particular, the method and system may be useful for plant at locations where light saturation of the plant is reached during the day, for example citrus orchard in Israel. Indeed, the success of the dual-use concept behind agrivoltaic systems depends mostly on the type of crop and on the system's ability to adjust shading in accordance with the plants' requirements. Optimal shading levels and their timing are not uniform across all plants. For example, there are plants with a photosynthetic rate that reaches light saturation at relatively low radiation intensity, such as Pitaya as illustrated in FIG. 4A. Such plants reach the saturation point at radiation intensities of 210 micromolar photons per square meter, so in Israel's climatic conditions, where the radiation intensity at noon reaches values of about 2000 micromolar photons per square meter, sun protection (40-60% shade) is necessary. In contrast, other plants need a large amount of solar radiation to reach the saturation level, and it is economically counterproductive to install overhead agrivoltaic systems for them. For example, as shown in FIG. 4B, cotton plants require about 1800 micromoles of photons per square meter in order to reach the saturation of the photosynthetic system. In contrast, as shown in FIG. 4C, citrus trees reach light saturation already at a radiation intensity of 800 micromoles of photons per square meter.

As such, those skilled in the art to which the present invention pertains, can appreciate that while the present invention has been described in terms of preferred embodiments, the concept upon which this disclosure is based may readily be utilized as a basis for the designing of other structures, systems and processes for carrying out the several purposes of the present invention.

The various illustrative logical blocks, modules, and algorithm steps described in connection with the embodiments disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing any departure from the scope of the disclosure.

It will also be understood that the system according to the present disclosure may be, at least partly, implemented on a suitably programmed computer. Likewise, the present disclosure contemplates a computer program being readable by a computer for executing the method of the invention. The present disclosure further contemplates a non-transitory computer-readable memory tangibly embodying a program of instructions executable by the computer for executing the method of the present disclosure.

Also, it is to be understood that the phraseology and terminology employed herein are for the purpose of description and should not be regarded as limiting.

It should be noted that the words “comprising”, “including” and “having” as used throughout the appended claims are to be interpreted to mean “including but not limited to”. The indefinite articles “a” and “an,” as used herein in the specification and in the claims, unless clearly indicated to the contrary, should be understood to mean “at least one.” The phrase “and/or,” as used herein in the specification and in the claims, should be understood to mean “either or both” of the elements so conjoined, i.e., elements that are conjunctively present in some cases, and disjunctively present in other cases.

It is important, therefore, that the scope of the invention is not construed as being limited by the illustrative embodiments set forth herein. Other variations are possible within the scope of the present invention as defined in the appended claims. Other combinations and sub-combinations of features, functions, elements and/or properties may be claimed through amendment of the present claims or presentation of new claims in this or a related application. Such amended or new claims, whether they are directed to different combinations or directed to the same combinations, whether different, broader, narrower or equal in scope to the original claims, are also regarded as included within the subject matter of the present description.

1-22. (canceled)

23. A method in an agrivoltaic system including photovoltaic panels disposed to cast a shadow on plants when irradiated by sunlight, said photovoltaic panels being controllable for adjusting said shadow, the method comprising:
(a) obtaining a comparison signal indicative of a comparison between a temperature of ambient air and a temperature of the plants; and
(b) controlling one or more of said photovoltaic panels to adjust the shadow cast by said one or more photovoltaic panels on the plants using said comparison signal.

24. The method of claim 23, wherein the controlling of said photovoltaic panels is performed to maintain a predetermined relationship between the temperature of the plants and ambient air temperature.

25. The method of claim 23, wherein the comparison signal is indicative of a difference and/or a ratio between ambient air temperature and the plant temperature.

26. The method according to claim 23, wherein controlling one or more of said photovoltaic panels using the comparison signal comprises determining whether said difference or ratio between ambient air temperature and the plant temperature exceeds a threshold.

27. The method according to claim 23, wherein the comparison signal is obtained repeatedly over time and wherein controlling one or more of said photovoltaic panels using said comparison signal comprises using the comparison signal obtained at several points in time.

28. The method according to claim 23, wherein controlling one or more of said photovoltaic panels comprises:
(a) determining a current shadow cast by the photovoltaic panels on the plants;
(b) computing a desired shadow adjustment of the shadow cast by said one or more photovoltaic panels on the plants using said comparison signal; and
(c) controlling one or more of said photovoltaic panels to achieve said desired shadow adjustment.

29. The method according to claim 23, wherein controlling one or more photovoltaic panels is performed such that the shadow cast by said one or more photovoltaic panels on the plants is increased when the signal is indicative that the temperature of the plants increases and approaches or exceeds ambient air temperature.

30. The method according to claim 23, wherein controlling one or more photovoltaic panels is performed such that the shadow cast by said one or more photovoltaic panels on the plants is decreased when the signal is indicative that the temperature of the plants decreases and approaches or goes below ambient air temperature.

31. The method according to claim 23, wherein said method is performed repeatedly at any of an hourly, daily and/or seasonal periodicity.

32. The method according to claim 23, wherein the temperature of the plants is a temperature of a canopy of the plants.

33. The method according to claim 23, wherein the photovoltaic panels are movable and wherein controlling said one or more photovoltaic panels comprises adjusting a position and/or an orientation of said one or more photovoltaic panels.

34. The method according to claim 23, wherein the one or more photovoltaic panels are rotatable around an axis and wherein controlling one or more photovoltaic panels comprises rotating the one or more photovoltaic panels around said axis.

35. The method according to claim 23, wherein controlling one or more photovoltaic panels is performed to also reduce a decrease in the generation of electricity by the one or more photovoltaic panels.

36. The method according to claim 23, further comprising an overruling pattern in case of meteorological event.

37. An apparatus for use in an agrivoltaic system including photovoltaic panels disposed so as to cast a shadow on plants when irradiated by sunlight, said photovoltaic panels being controllable for adjusting said shadow, said apparatus being configured for:
(a) obtaining a comparison signal indicative of a comparison between a temperature of ambient air and a temperature of the plants; and
(b) controlling one or more of said photovoltaic panels to adjust the shadow cast by said one or more photovoltaic panels on the plants using said comparison signal.

38. The apparatus according to claim 37, further comprising:
(a) an input port configured to receive a signal indicative of a temperature of ambient air and a signal indicative of a temperature of the plants;
(b) an actuator operatively coupled to the photovoltaic panels and configured for controlling said photovoltaic panels; and
(c) a processor operatively coupled to the actuator and to the input port and configured for:
i) comparing the temperature of ambient air and the temperature of the plants using the signal indicative of the temperature of ambient air and the signal indicative of the temperature of the plants, thereby obtaining the comparison signal indicative of a comparison between the temperature of ambient air and the temperature of the plants;
ii) computing a desired shadow adjustment of the shadow cast by the photovoltaic panels on the plants using said comparison signal; and
iii) outputting control commands to the actuator to control one or more of said photovoltaic panels and adjust the shadow cast by said one or more photovoltaic panels on the plants to achieve said desired shadow adjustment.

39. A photovoltaic system, comprising:
(a) photovoltaic panels intended to be disposed so as to cast a shadow on plants when irradiated by sunlight, said photovoltaic panels being controllable for adjusting a shadow cast by said photovoltaic panels on the plants; and
(b) an apparatus being configured for:
i) obtaining a comparison signal indicative of a comparison between a temperature of ambient air and a temperature of the plants;
ii) controlling one or more of said photovoltaic panels to adjust the shadow cast by said one or more photovoltaic panels on the plants using said comparison signal.

40. The photovoltaic system according to claim 39, further comprising
(a) a plant temperature sensor configured to provide the signal indicative of the temperature of the plants; and
(b) an air temperature sensor configured to provide the signal indicative of the ambient air.

41. The photovoltaic system according to claim 40, wherein the plant temperature sensor comprises an infrared camera and/or thermocouples.

42. The photovoltaic system according to claim 39, further comprising a solar radiation sensor.

43. The photovoltaic system according to claim 39, further comprising at least some fixed photovoltaic panels.

44. The photovoltaic system according to claim 39, wherein the photovoltaic panels comprise one or more semi-transparent and/or bifacial panels.
